(19) United States
(12) Patent Application Publication
(10) Pub. No.: US 2010/0226467 A1
(43) Pub. Date: Sep. 9, 2010

(54) FRAME NUMBER DETECTING DEVICE

(75) Inventors: Tatsuhisa Furukawa, Kanagawa-ken (JP); Hidehiro Matsuoka, Kanagawa-ken (JP); Masami Aizawa, Kanagawa-ken (JP)

Correspondence Address: TUROCY & WATSON, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/714,751

(22) Filed: Mar. 1, 2010

(30) Foreign Application Priority Data
Mar. 3, 2009 (JP) 2009-049649

(51) Int. Cl. H04L 7/02

(52) U.S. Cl. 375/359

(57) ABSTRACT

A frame number detecting device includes: a symbol counter that receives a received signal including frames each of which is formed of a predetermined number of symbols, and outputs a count value as a symbol number for each of the symbols by incrementing the count value by one every time one symbol is inputted, each of the frames including a frame synchronization signal including a part obtained by shifting a frame synchronization signal of a different frame on a symbol-by-symbol basis according to a predetermined rule; a sequence storage that stores a synchronization sequence based on at least one of the frame synchronization signals included in the received signal, and a pattern matching unit that performs pattern matching between the synchronization sequence stored in the sequence storage and the received signal.

### CROSS REFERENCE TO RELATED APPLICATIONS

This application is based on and claims the benefit of priority from prior Japanese Application No. 2009-049649, filed on Mar. 3, 2009, the entire contents of which are incorporated herein by reference.

### BACKGROUND OF THE INVENTION

1. Field of the Invention

The present invention relates to a frame number detecting device which obtains a frame number in transmission data in the broadcasting and communication field.

2. Description of the Related Art

In the broadcasting and communication field, data is transmitted in units of blocks of a predetermined length such as frames. A receiver detects an identifier, such as a frame synchronization signal, stored in the transmitted data for every frame. Thereby, the receiver establishes frame synchronization, and performs decoding on a frame-by-frame basis.

For example, in Digital Terrestrial Multimedia Broadcast (DTMB), which is the terrestrial digital broadcasting standard in China (People's Republic of China), a frame consists of a frame body (hereinafter also referred to as FB) and a frame header (hereinafter also referred to as FH). The frame body stores therein 3780 symbols indicating a combination of modulated source stream data and system information. The frame header stores therein a known pseudo-random noise sequence for identifying the frame (hereinafter referred to as PN sequence).

A PN sequence in a frame header is generated by a linear feedback shift register (LFSR). The LFSR is capable of generating a known cyclic PN sequence, and produces known frame headers by cyclically extending the generated PN sequence defined by the generating polynomial. Since including a known PN sequence, a frame header can be used not only for detecting frame synchronization but also as a pilot signal, and thus can be used for decoding processing including transmission path response estimation and the like.

DTMB has three modes, i.e., FH Mode 1 to FH Mode 3. In FH Mode 1 and FH Mode 3, a PN sequence in a frame header has a pattern which is not the same throughout all frames, but changes on a frame-by-frame basis. PN sequences in respective frame headers have patterns that change on a frame-by-frame basis without following a single pattern throughout frames. For this reason, in order to use a PN sequence in a frame header as a pilot signal in FH Mode 1 and FH Mode 3, it is necessary to estimate a PN sequence in a frame header for every frame.

Now, the LFSR in FH Model, for example, generating 255 kinds of PN sequences by varying an initial value set in the LFSR in FH model. Some of the 255 kinds of PN sequences which the LFSR in FH Mode 1 is capable of generating are employed as PN sequence patterns for frame headers. In FH Mode 1, PN sequences in respective frame headers correspond respectively to initial values of the LFSR. The relationship between frame numbers allocated to respective frames and the initial values of the LFSR is specified in the specification.

In DTMB, a superframe is defined by a predetermined number of frames depending on each mode. The time length of a superframe is fixed to 125 ms. A superframe is assumed to be used in systems requiring time checking such as a GPS. Superframe synchronization can be established by estimating a frame number.

Moreover, estimating a frame number of a frame is equivalent to estimating perfectly a PN sequence included in the frame, and thus to estimating perfectly a pilot signal. In sum, the decoding performance is expected to be improved if a frame number can be detected.

Conceivable methods for obtaining a frame number include a method by pattern matching. In the method by pattern matching, a table is first prepared in which initial values of the LFSR are associated with PN sequences used for frame headers. Then, the frame number of a current frame is determined by pattern matching of the PN sequence of the frame header with the initial values of the LFSR by use of the table.

However, this method has a drawback of an increase in circuit size since requiring a relatively large table for holding the initial values of the LFSR.

Meanwhile, Japanese Patent Application Publication No. 2003-273824 discloses a matched filter which allows a reduction in size and in power consumption of a correlation operational circuit for synchronization detection, and a correlation detection method using the matched filter. However, the detection of a frame number using the technique in Japanese Patent Application Publication No. 2003-273824 has a problem that the number of correlation operations increases with the number of frame numbers, consequently requiring an extremely long period of time for the detection of a frame number.

### SUMMARY OF THE INVENTION

According to an aspect of the present invention, a frame number detecting device includes: a symbol counter that receives a received signal including frames each of which is formed of a predetermined number of symbols, and outputs a count value as a symbol number for each of the symbols by incrementing the count value by one every time one symbol is inputted, each of the frames including a frame synchronization signal including a part obtained by shifting a frame synchronization signal of a different frame on a symbol-by-symbol basis according to a predetermined rule; a sequence storage that stores a synchronization sequence based on at least one of the plurality of frame synchronization signals included in the received signal; a pattern matching unit that performs pattern matching between the synchronization sequence stored in the sequence storage and the received signal; a timing detector that detects the frame synchronization signals of the respective frames on the basis of a result of the pattern matching performed by the pattern matching unit, and outputs the symbol numbers received at the respective detected timings; and a frame number obtaining unit that obtains each frame number of the received signal on the basis of the predetermined rule and the symbol numbers received from the timing detector.

According to another aspect of the present invention, a frame number detecting device includes a symbol counter that receives a received signal including frames each of which is formed of a predetermined number of symbols, and outputs a count value as a symbol number for each of the symbols by incrementing the count value by one every time one symbol is inputted, each of the frames including a frame synchronization signal including a part obtained by shifting a frame synchronization signal of a different frame on a symbol-by-symbol basis according to a predetermined rule; a sequence generator that generates a synchronization sequence based on at least one of the plurality of frame synchronization signals included in the received signal; a pattern matching unit that performs pattern matching between the synchronization sequence generated by the sequence generator and the received signal; a timing detector that detects the frame synchronization signals of the respective frames on the basis of a result of the pattern matching performed by the pattern matching unit, and outputs the symbol numbers received at the respective detected timings; and a frame number obtaining unit that obtains each frame number of the received signal on the basis of the predetermined rule and the symbol numbers received from the timing detector.

### BRIEF DESCRIPTION OF THE DRAWINGS

FIG. 1 is a block diagram showing a frame number detecting device according to a first embodiment of the present invention.

FIGS. 2A to 2C are diagrams each illustrating a frame structure for DTMB.

FIGS. 3A and 3B are circuit diagrams each showing a specific circuit structure of a LFSR for generating a frame header for DTMB.

FIG. 4 is a graph showing a correlation result obtained by pattern matching, in which symbol numbers are given on the horizontal axis whereas correlation values are given on the vertical axis.

FIG. 5 is a diagram for illustrating arrangement of a PN sequence in frame headers for DTMB broadcast signal.

FIG. 6 is a chart for illustrating an operation in the first embodiment.

FIG. 7 is a chart for illustrating the operation in the first embodiment.

FIG. 8 is a chart for illustrating the operation in the first embodiment.

FIG. 9 is a chart for illustrating the operation in the first embodiment.

FIG. 10 is a block diagram showing a second embodiment of the present invention.

### DETAILED DESCRIPTION OF THE EMBODIMENTS

A description will be given of embodiments of the present invention in detail below with reference to the drawings.

### First Embodiment

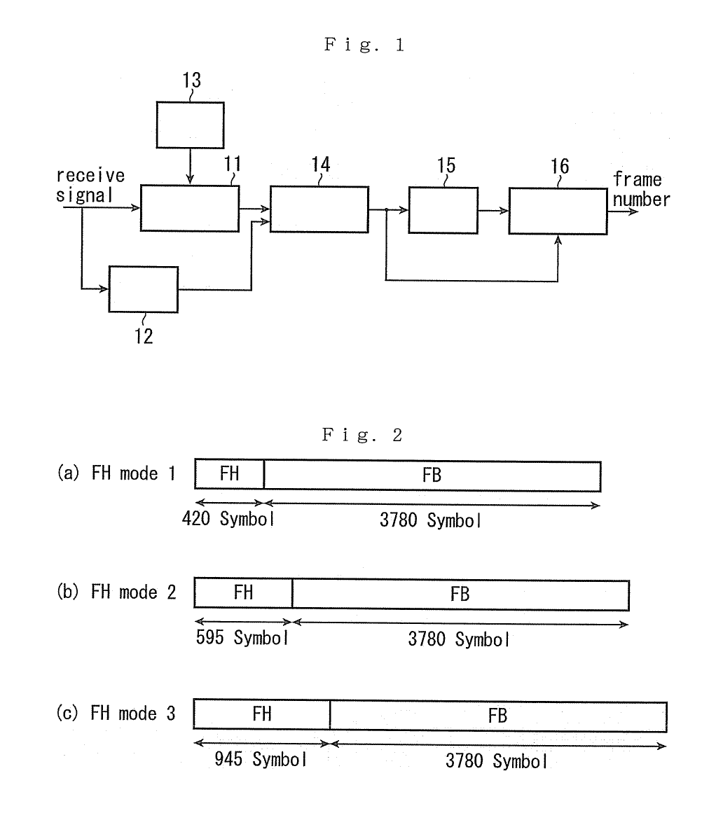

FIG. 1 is a block diagram showing a frame number detecting device according to a first embodiment of the present invention. An Example shown in this embodiment is a case where the frame number detecting device is used for obtaining a frame number in DTMB.

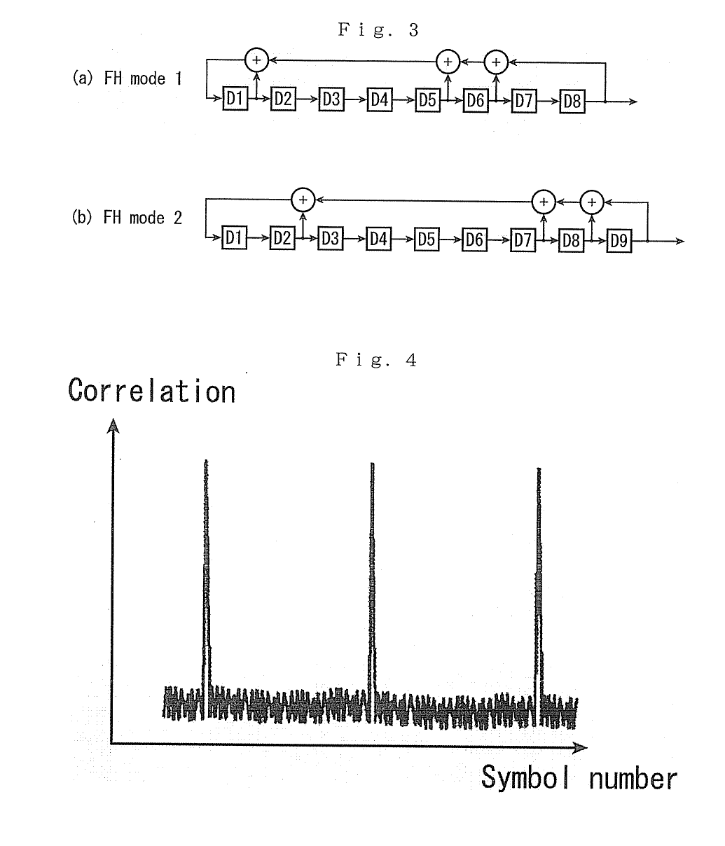

First, a DTMB broadcast signal will be described with reference to FIGS. 2 to 4. FIGS. 2A to 2C each show a frame structure for DTMB, and correspond to FH Mode 1 to FH Mode 3, respectively. FIGS. 3A and 3B are circuit diagrams each showing a specific circuit structure of a LFSR for generating a frame header for DTMB.

As shown in FIG. 2, each frame for DTMB consists of a frame header (FH) and a frame body (FB). A frame body has a symbol length of 3780 in every mode. A frame header has a symbol length which differs from one mode to another: 420 for FH Mode 1; 595 for FH Mode 2; and 945 for FH Mode 3.

FIG. 3A shows a structure of a LFSR for generating a frame header for FH Mode 1, whereas FIG. 3B shows a structure of a LFSR for generating a frame header for FH Mode 3. The LFSR shown in FIG. 3A is formed of eight cascade-connected delay devices D1 to D8 and three adders. The LFSR shown in FIG. 3A is capable of generating a PN sequence for a frame header of a certain frame for FH Mode 1 by giving the delay devices D1 to D8 a predetermined initial value. Likewise, the LFSR shown in FIG. 3B is formed of nine cascade-connected delay devices D1 to D9 and three adders. The LFSR shown in FIG. 3B is capable of generating a PN sequence for a frame header of a certain frame for FH Mode 3 by giving the delay devices D1 to D9 a predetermined initial value.

A received signal shown in FIG. 1 is a DTMB broadcast signal of either FH Mode 1 or FH Mode 3. This broadcast signal is obtained by causing an A/D converter not shown to digitize a signal received by an antenna not shown. The received signal is supplied to a pattern matching unit 11 and a symbol counter 12. The symbol counter 12 is reset when reaching the number of symbols constituting a frame of the received signal. The symbol counter 12 increments a count value every time a symbol of the received signal is inputted thereto, and outputs the counted value (hereinafter referred to as a symbol number) to a timing detector 14.

A synchronization sequence storage 13 stores therein a pattern which is partially or entirely the same as that of a PN sequence included in each frame header of the received signal (hereinafter referred to as a synchronization sequence). The pattern matching unit 11 is also given a synchronization sequence from the synchronization sequence storage 13.

The pattern matching unit 11, to which symbols of the received signal are sequentially inputted, performs pattern matching processing between the received signal of a predetermined symbol length and the synchronization sequence received from the synchronization sequence storage 13, and outputs, to the timing detector 14, a result of correlation between the received signal and the synchronization sequence received from the synchronization sequence storage 13.

Here, various methods can be employed for the pattern matching processing performed by the pattern matching unit 11, including sliding correlation processing and matching filtering, for example. The pattern matching unit 11 outputs, for example, an impulse-shaped correlation waveform representing correlation between the received signal and the synchronization sequence.

FIG. 4 is a graph showing the correlation result obtained by pattern matching, in which symbol numbers are given on the horizontal axis whereas correlation values are given on the vertical axis. As shown in FIG. 4, the pattern matching unit outputs an extremely high correlation value for the predetermined number of symbols. The extremely high correlation value is acquired at a timing in each frame at which the pattern matching unit 11 detects in its pattern matching processing that the synchronization sequence received from the synchronization sequence storage 13 is most identical to apart or whole of PN sequence included in the frame of the received signal.

The timing detector 14 detects the timing that gives the highest correlation value in each frame, and outputs, as a synchronization detected symbol number, a symbol number received from the symbol counter 12 at the detected timing, to an averaging unit 15 and a frame number detector 16.

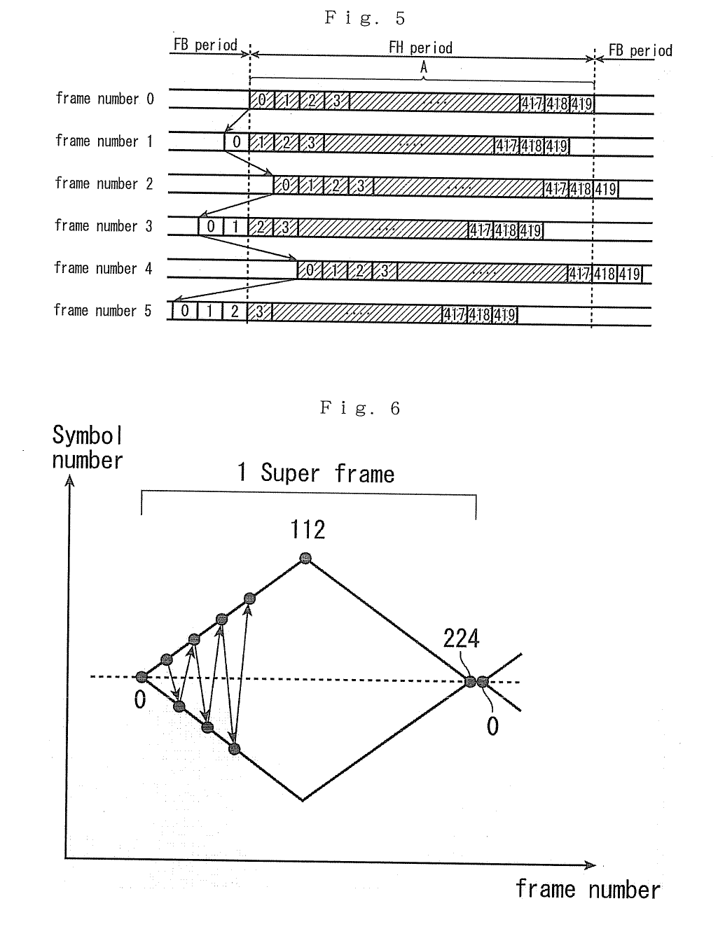

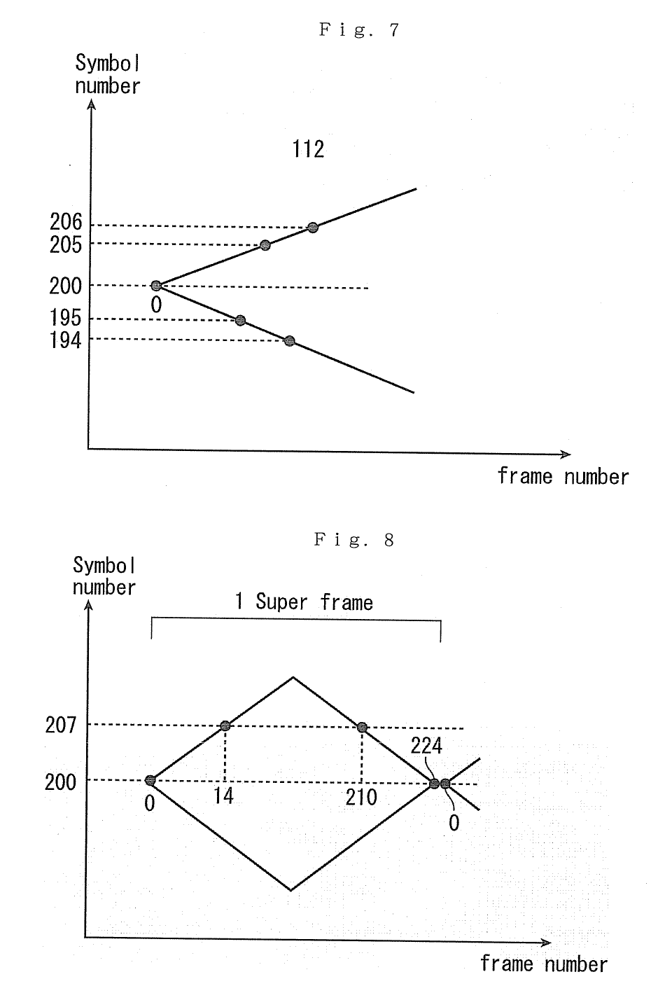

FIG. 5 is a diagram for illustrating arrangement of a PN sequence in frame headers for DTMB broadcast signal. Although a PN sequence for FH Mode 1 is shown as an example in FIG. 5, a PN sequence is arranged in the same manner in frame headers for FH Mode 3. In FIG. 5, frame numbers 0 to 5 respectively correspond to first to sixth frames constituting a superframe for FH Mode 1. FIG. 5 shows that a sequence A is a PN sequence of 420 symbols constituting the frame header of a frame number 0. FIG. 5 also shows that: included in the frame header of the frame of a frame number 1 next to the frame number 0 are symbol numbers 1 to 419 obtained by shifting forward by one symbol the sequence A which is in the frame of the frame number 0; included in the frame header of the frame of a frame number 2 next to the frame number 1 are symbol numbers 0 to 418 obtained by shifting backward by one symbol the sequence A which is in the frame of the frame number 0.

Likewise, FIG. 5 shows that: included in the frame header of the frame of a frame number 3 next to the frame number 2 are symbol numbers 2 to 419 obtained by shifting forward by two symbols the sequence A which is in the frame of the frame number 0; included in the frame header of the frame of a frame number 4 next to the frame number 3 are symbol numbers 0 to 417 obtained by shifting backward by two symbols the sequence A which is in the frame of the frame number 0.

After that, in the same way, the PN sequence in frame headers for DTMB broadcast signal inverts its shift direction for every frame number, and increases or decreases its shift amount by one symbol for every two frame numbers. In other words, a part of the sequence A is included in each of the frame headers of the frames.

The synchronization sequence storage 13 stores therein a synchronization sequence which corresponds to the sequence A. The pattern matching unit 11 sequentially compares the received signal with the sequence A. Then, the timing detector 14 obtains, from the outputs of the pattern matching unit 11, sequence A detection timings in the received signal sequentially inputted to the pattern matching unit 11. Since every frame includes a part or whole of the sequence A, a peak of correlation values appears for every frame. The peak position for each frame shifts by a number of symbols corresponding to the frame number in accordance with the feature shown in FIG. 5.

For example, assume a case where the timing detector 14 firstly detects the sequence A at a certain timing, then secondly detects the sequence A at a timing earlier by one symbol than the certain timing, and then thirdly detects the sequence A at a timing later by one symbol than the certain timing. In this case, it can be estimated that the firstly-detected sequence A is included in the frame of the frame number 0.

The symbol counter 12 is set to its initial value at a certain symbol timing, and increments a count value every time a symbol of the received signal is inputted thereto. After that, the symbol counter 12 is reset when reaching the number of symbols constituting a frame. In other words, the counted values from the symbol counter 12 (symbol numbers) are in one-to-one correspondence with the positions of respective symbols in one frame. Thus, it is possible to determine where in a frame the sequence A is inserted, by obtaining a sequence A detection timing on the basis of symbol numbers from the symbol counter 12.

The averaging unit 15 constituting a frame number obtaining unit averages the synchronization detected symbol numbers received from the timing detector 14. For example, the averaging unit 15 averages two or more of the synchronization detected symbol numbers consecutively received. A symbol number corresponding to the frame number 0 can be obtained by the averaging of the two or more consecutive synchronization detected symbol numbers, as will be described later. The averaging unit 15 outputs, to the frame number detector 16 as a reference symbol number, the symbol number corresponding to the frame number 0 obtained by the averaging.

The frame number detector 16 constituting a frame number obtaining unit is sequentially given the synchronization detected symbol numbers from the timing detector 14. On the basis of comparison of the reference symbol number with a currently-received synchronization detected symbol number and a transition status of the sequentially-received synchronization detected symbol numbers, the frame number detector 16 detects a frame number currently being received, and outputs the detected frame number.

With reference to FIGS. 6 to 9, an operation of the first embodiment will be described next. FIGS. 6 to 9 are each a chart showing the relationship between the synchronization detected symbol number and the frame number, in which frame numbers are given on the horizontal axis whereas symbol numbers are given on the vertical axis.

The symbol counter 12 is set to its initial value at a certain timing, and therefore symbol numbers which the symbol counter 12 respectively output for symbols of a head frame are uncertain. The pattern matching unit 11 is given, from the synchronization sequence storage 13, a synchronization sequence which corresponds to a part or whole of PN sequence included in every frame header of the received signal. Thereby, the pattern matching unit 11 performs pattern matching between the received signal and the synchronization sequence while the symbol counter 12 increments a count value every time a symbol of the received signal is inputted thereto. In the case of FH Mode 1, a symbol number to be outputted from the timing detector 14 is any of 0 to 4199.

The timing detector 14 is given the correlation result from the pattern matching unit 11, determines that a synchronization sequence is detected at each timing at which the correlation value reaches its peak, and outputs, as a synchronization detected symbol number, the counted value (symbol number) of the symbol counter 12 at the timing. Here, a synchronization detected symbol number is detected for every frame.

FIG. 6 is a chart in which a synchronization detected symbol number detected for every frame in FH Mode 1 is shown as a black circle. Since the PN sequence arrangement has the feature shown in FIG. 5, as shown in FIG. 6, the synchronization detected symbol number repetitively increases or decreases every time the frame number changes by one, and its increase/decrease amount is reduced as the frame number gets closer to 0. Note that, only a part of black circles indicating synchronization detected symbol numbers are shown on solid lines in FIGS. 6 to 9 for simplification of the drawings.

In the first embodiment, the detection of only three or more synchronization detected symbol numbers allows obtaining the synchronization detected symbol number corresponding to the frame number 0 (reference symbol number) and obtaining the frame number of a currently received frame in which a synchronization detected symbol number is detected, by use of the fact that the synchronization detected symbol number has the feature shown in FIG. 6.

Specifically, the averaging unit 15 obtains the reference symbol number by the averaging of two or more consecutive synchronization detected symbol numbers. For example, consider a case where four consecutive synchronization detected symbol numbers are 195, 205, 194 and 206, as shown in FIG. 7. To be more specific, the synchronization detected symbol number detected in a certain first frame is 195, the synchronization detected symbol number detected in the next frame is 205, the synchronization detected symbol number detected in the next frame is 194, and the synchronization detected symbol number detected in the next frame is 206.

In this case, the averaging unit 15 detects that the reference symbol number is 200 by (195+205+194+206)/4=200. As shown in FIG. 6, the relationship between the frame number and the synchronization detected symbol number is symmetric about a central line passing through the frame numbers 0 and 224. The use of this symmetric relationship allows the averaging unit 15 to estimate that the symbol number 200 obtained by the averaging unit 15 is the synchronization detected symbol number detected when the frame of the frame number 0 is inputted (reference symbol number). The averaging unit 15 outputs the reference symbol number thus detected to the frame number detector 16.

Note that, the averaging unit 15 is capable of detecting the reference symbol number by the averaging of and an even number, two or more, of synchronization detected symbol numbers. If the calculation result in its averaging processing includes decimal number, the averaging unit 15 rounds off the calculation result in its averaging processing.

Alternatively, the averaging unit 15 may sequentially average symbol numbers received from the timing detector 14, and sequentially output reference symbol numbers. Still alternatively, the averaging unit 15 may perform average processing after power on, after switching of channels, for every predetermined frame cycles or at other timings, hold reference symbol numbers obtained by the processing, and then output the reference symbol numbers.

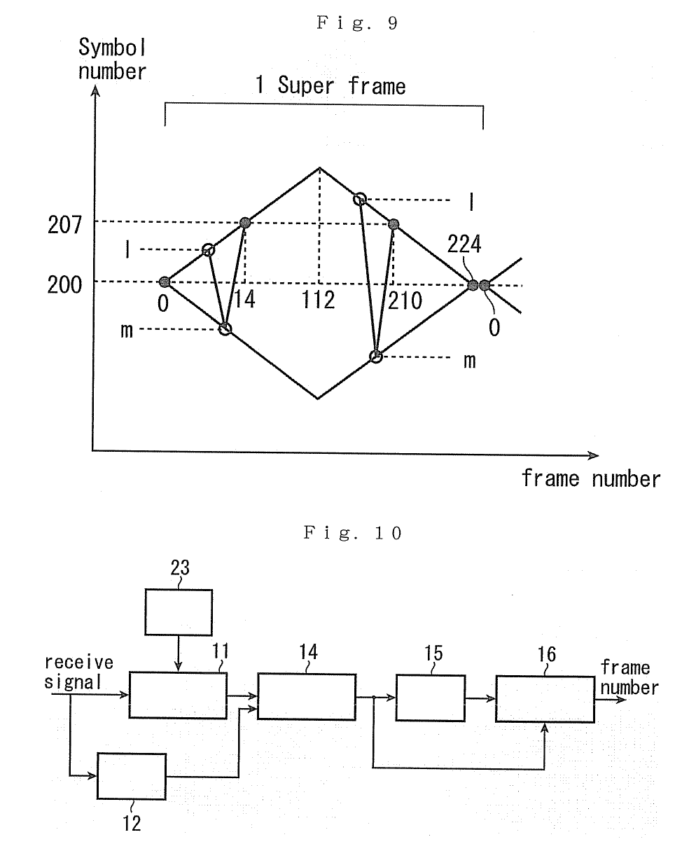

The frame number detector 16 calculates a frame number currently received (current frame number) on the basis of a synchronization detected symbol number currently received from the timing detector 14 (current synchronization detected symbol number) and the reference symbol number received from the averaging unit 15. FIGS. 8 and 9 are charts for illustrating a detection operation performed by the frame number detector 16 when the current synchronization detected symbol number is 207.

As shown in FIG. 6, in FH Mode 1, the frame number and the synchronization detected symbol number is symmetric about a central line passing through the frame number 112. For this reason, two current frame numbers are conceivable for the current synchronization detected symbol number, as shown in FIG. 8. In FH Mode 1, the two current frame number candidates A and B can be expressed with the following formulae (1):

current frame number A=(¦current synchronization detected symbol number−reference symbol number¦*2)−X (here, X=1 when current synchronization detected symbol number <reference symbol number; otherwise X=0);

current frame number B=225−(¦current synchronization detected symbol number−reference symbol number¦*2)−Y (here, Y=1 when current synchronization detected symbol number=reference symbol number; otherwise Y=0) (1),

where * represents multiplication.

When the reference symbol number is 200 and the current synchronization detected symbol number is 207, the two current frame number candidates A and B can be calculated by the following formulae (2):

current frame number A=(¦207−200¦*2)−0=14;

current frame number B=225−(¦207−200¦*2)−1=210 (2).

Subsequently, the frame number detector 16 determines whether the current frame number is smaller than or larger than the frame number 112 (i.e., current frame number A or current frame number B), by using a transition status of synchronization detected symbol numbers having been received. FIG. 9 is a chart showing an example of obtaining the current frame number by using two synchronization detected symbol numbers having been received.

It is assumed here that the two synchronization detected symbol numbers having been received are m and 1, and the current synchronization detected symbol number is n. As is apparent from FIG. 9: ¦1¦<¦m¦<¦n¦ is satisfied when the current frame number is smaller than 112; ¦1¦>¦m¦>¦n¦ is satisfied when the current frame number is larger than 112.

Accordingly, the frame number detector 16 determines that: the current frame number is smaller than 112 when ¦1−m¦<¦m−n¦ is satisfied; the current frame number is larger than 112 when ¦1−m¦>¦m−n¦ is satisfied.

For example, when the timing detector 14 has detected that the synchronization detected symbol numbers are the symbol number 206 shown in FIG. 7 and symbol numbers 193 and 207, the frame number detector 16 detects that the frame number which corresponds to the current synchronization detected symbol number 207 is 14. The frame number detector 16 outputs information on the frame number thus detected.

It is apparent here that the frame number detector 16 may employ various methods other than the method shown in the aforementioned example to detect the current frame number. For example, the frame number detector 16 may obtain the current frame number by using different formulae other than the formulae (1), or by referring to a table which is prepared in advance and in which the relationship between the symbol number and the frame number is described.

As described above, with the frame number detecting device according to the first embodiment, a frame number can be detected with a small circuit size since the synchronization sequence storage 13 has only to store a synchronization sequence which corresponds to a part or whole of the PN sequence included in one frame header. Further, a frame number can be detected in a short period of time and with a small amount of calculation since the detection of only three synchronization detected symbol numbers is needed to obtain the current frame number. Furthermore, a frame number can be detected without establishing frame synchronization.

Note that, as described above, the synchronization sequence storage 13 does not necessarily have to store symbols which are identical to all the symbols constituting a PN sequence included in the frame header. The synchronization sequence storage 13 has only to store a part of the symbols of the PN sequence which are enough to specify, in the pattern matching processing, the symbol number that gives the highest correlation value in each frame.

### Second Embodiment

FIG. 10 is a block diagram showing a second embodiment of the present invention. In FIG. 10, the same components as those of FIG. 1 are given the same reference numerals, and description thereof will be omitted.

The second embodiment is different from the first embodiment in that a synchronization sequence generator 23 is provided instead of the synchronization sequence storage 13.

The synchronization sequence generator 23 is formed of the same circuit as the LFSR shown in FIGS. 3A and 3B, and is capable of generating a PN sequence for a frame header upon receipt of an initial value. A synchronization sequence generated in the synchronization sequence generator 23 is provided to the pattern matching unit 11.

Other configurations and advantageous effects of the second embodiment are the same as those of the first embodiment. In addition, the frame number detecting device according to the second embodiment has an advantage of realizing a smaller circuit size than that of the first embodiment since the amount of data of a synchronization sequence to be stored is smaller than that of the first embodiment.

In the embodiments described above, a description has been given of an example in which the received signal is time domain data. However, the present invention is applicable in the same manner to a case where the received signal is frequency domain data.

What is claimed is:

1. A frame number detecting device comprising:
a symbol counter that receives a received signal including frames each of which is formed of a predetermined number of symbols, and outputs a count value as a symbol number for each of the symbols by incrementing the count value by one every time one symbol is inputted, each of the frames including a frame synchronization signal including a part obtained by shifting a frame synchronization signal of a different frame on a symbol-by-symbol basis according to a predetermined rule;
a sequence storage that stores a synchronization sequence based on at least one of the plurality of frame synchronization signals included in the received signal;
a pattern matching unit that performs pattern matching between the synchronization sequence stored in the sequence storage and the received signal;
a timing detector that detects the frame synchronization signals of the respective frames on the basis of a result of the pattern matching performed by the pattern matching unit, and outputs the symbol numbers received at the respective detected timings; and
a frame number obtaining unit that obtains each frame number of the received signal on the basis of the predetermined rule and the symbol numbers received from the timing detector.

2. A frame number detecting device comprising:
a symbol counter that receives a received signal including frames each of which is formed of a predetermined number of symbols, and outputs a count value as a symbol number for each of the symbols by incrementing the count value by one every time one symbol is inputted, each of the frames including a frame synchronization signal including a part obtained by shifting a frame synchronization signal of a different frame on a symbol-by-symbol basis according to a predetermined rule;
a sequence generator that generates a synchronization sequence based on at least one of the plurality of frame synchronization signals included in the received signal;
a pattern matching unit that performs pattern matching between the synchronization sequence generated by the sequence generator and the received signal;
a timing detector that detects the frame synchronization signals of the respective frames on the basis of a result of the pattern matching performed by the pattern matching unit, and outputs the symbol numbers received at the respective detected timings; and
a frame number obtaining unit that obtains each frame number of the received signal on the basis of the predetermined rule and the symbol numbers received from the timing detector.

3. The frame number detecting device according to any one of claims 1 and 2, wherein the frame number obtaining unit includes:
an averaging unit that averages the symbol numbers received from the timing detector, thereby estimates the symbol number corresponding to a reference frame number, and outputs the estimated symbol number as a reference symbol number; and
a frame number detector that detects the frame number of the received signal on the basis of the reference symbol number received from the averaging unit and the symbol numbers received from the timing detector.

4. The frame number detecting device according to claim 3, wherein the averaging unit performs the averaging at predetermined timings, for every predetermined cycle or in a consecutive manner.

5. The frame number detecting device according to any one of claims 1 to 4, wherein the received signal is any one of time domain data and frequency domain data.
